(19) United States
(12) Patent Application Publication
(10) Pub. No.: US 2020/0213644 A1
(43) Pub. Date: Jul. 2, 2020

(54) ADVERTISEMENT INSERTION IN VIDEOS

(71) Applicant: International Business Machines Corporation, Armonk, NY (US)

(72) Inventors: Nitin Gupta, Saharanpur (IN); Shashank Mujumdar, Nagpur (IN); Sameep Mehta, New Delhi (IN)

(21) Appl. No.: 16/238,308

(22) Filed: Jan. 2, 2019

(51) Int. Cl. H04N 21/234; G06Q 30/02; H04N 21/81; H04N 21/258

(52) U.S. Cl. CPC H04N 21/23424; G06Q 30/0269; H04N 21/25891; G06Q 30/0277; H04N 21/812; G06Q 30/0273

(57) ABSTRACT

One embodiment provides a method, including: obtaining at least one video into which an advertisement is to be inserted; selecting an advertisement for insertion into the at least one video, wherein the selecting comprises (i) analyzing the at least one video to identify context of the at least one video and (ii) selecting an advertisement that is related to the context of the at least one video; determining a location within the at least one video for insertion of the advertisement, wherein the determining a location comprises (i) identifying criticality of a scene within the video where the advertisement is to be inserted and (ii) selecting the location based upon the criticality of the scene; and inserting the advertisement within the at least one video at the determined location.

### BACKGROUND

A media consumer is often provided with different advertisements while consuming media. For example, when a user is watching television from a telecommunications provider, the provider inserts commercials during the television show. As another example, if a consumer is watching a movie, the movie frequently includes previews for other movies or products. However, with the increase in media consumption from streaming services, for example, media service providers providing television shows and videos from an Internet source, video sharing services, videos provided over social media sites, and the like, advertisers have to approach advertisements differently. Specifically, the advertisers generally cannot provide a traditional commercial that would be provided over a telecommunications provider. Instead the advertisements are traditionally provided as a pop-up within a window displaying the video, as an advertisement on a sidebar of a window displaying the video, or possibly provided as a frame within the video.

### BRIEF SUMMARY

In summary, one aspect of the invention provides a method comprising: obtaining at least one video into which an advertisement is to be inserted; selecting an advertisement for insertion into the at least one video, wherein the selecting comprises (i) analyzing the at least one video to identify context of the at least one video and (ii) selecting an advertisement that is related to the context of the at least one video; determining a location within the at least one video for insertion of the advertisement, wherein the determining a location comprises (i) identifying criticality of a scene within the video where the advertisement is to be inserted and (ii) selecting the location based upon the criticality of the scene; and inserting the advertisement within the at least one video at the determined location.

Another aspect of the invention provides an apparatus, comprising: at least one processor; and a computer readable storage medium having computer readable program code embodied therewith and executable by the at least one processor, the computer readable program code comprising: computer readable program code configured to obtain at least one video into which an advertisement is to be inserted; computer readable program code configured to select an advertisement for insertion into the at least one video, wherein the selecting comprises (i) analyzing the at least one video to identify context of the at least one video and (ii) selecting an advertisement that is related to the context of the at least one video; computer readable program code configured to determine a location within the at least one video for insertion of the advertisement, wherein the determining a location comprises (i) identifying criticality of a scene within the video where the advertisement is to be inserted and (ii) selecting the location based upon the criticality of the scene; and computer readable program code configured to insert the advertisement within the at least one video at the determined location.

An additional aspect of the invention provides a computer program product, comprising: a computer readable storage medium having computer readable program code embodied therewith, the computer readable program code executable by a processor and comprising: computer readable program code configured to obtain at least one video into which an advertisement is to be inserted; computer readable program code configured to select an advertisement for insertion into the at least one video, wherein the selecting comprises (i) analyzing the at least one video to identify context of the at least one video and (ii) selecting an advertisement that is related to the context of the at least one video; computer readable program code configured to determine a location within the at least one video for insertion of the advertisement, wherein the determining a location comprises (i) identifying criticality of a scene within the video where the advertisement is to be inserted and (ii) selecting the location based upon the criticality of the scene; and computer readable program code configured to insert the advertisement within the at least one video at the determined location.

A further aspect of the invention provides a method, comprising: obtaining a video for insertion of an ad, wherein the obtaining comprises identifying a category of the video based upon content in the video; obtaining an ad for insertion into the video, wherein the obtaining an ad comprises matching a category of the ad to the category of the video; selecting a position within a scene of the video for insertion of the ad, wherein the selecting comprises identifying a critical scene within the video; inserting the ad into the video, wherein the inserting comprises (i) replacing an object within a frame of the critical scene if an object of the ad is similar to the object within the frame and (ii) inserting, if an object cannot be replaced, the ad at a position within a frame of the critical scene, the position being identified as a non-featured frame element.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of inserting an advertisement, which is relevant to a video, within a location of a scene within the video, with the scene being selected based upon a criticality of the scene.

FIG. 2A-2C illustrates advertisement insertion examples based upon the criticality of the scene.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

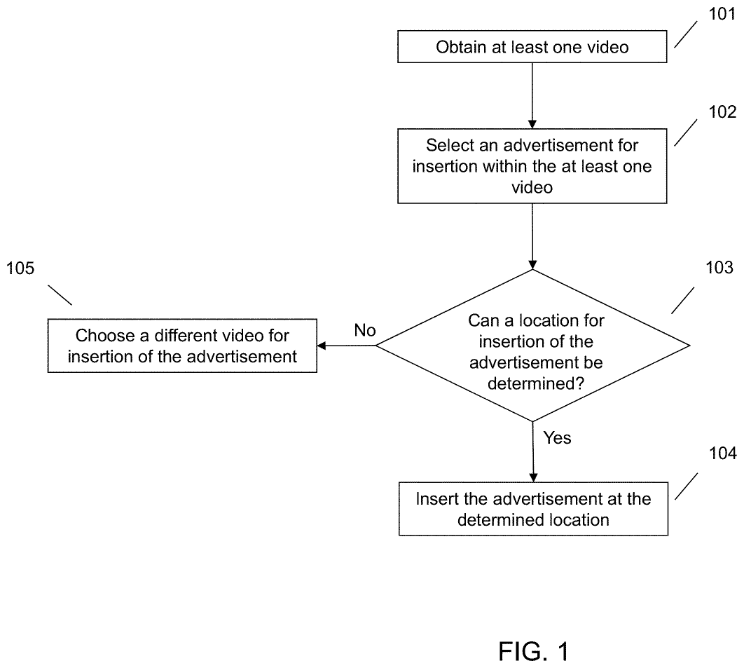

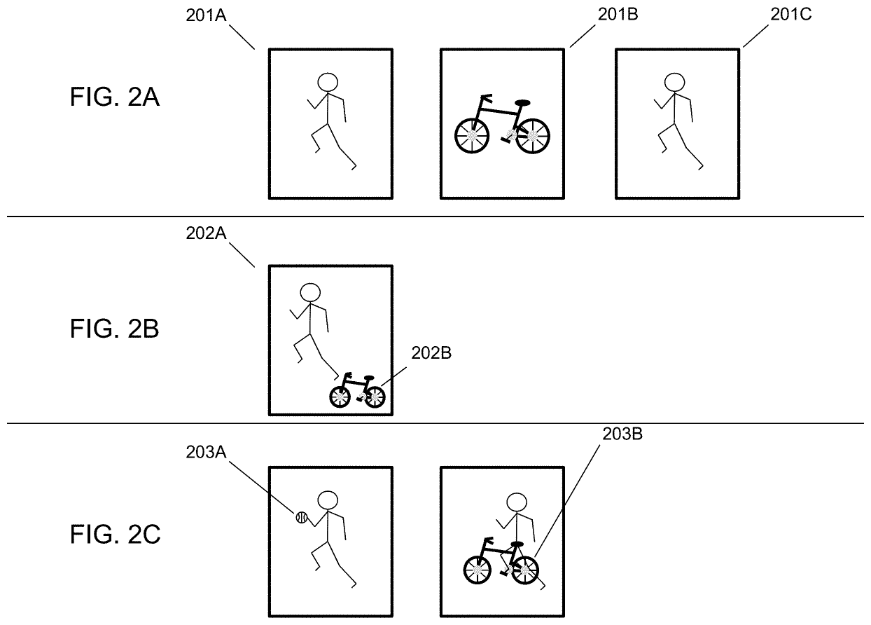

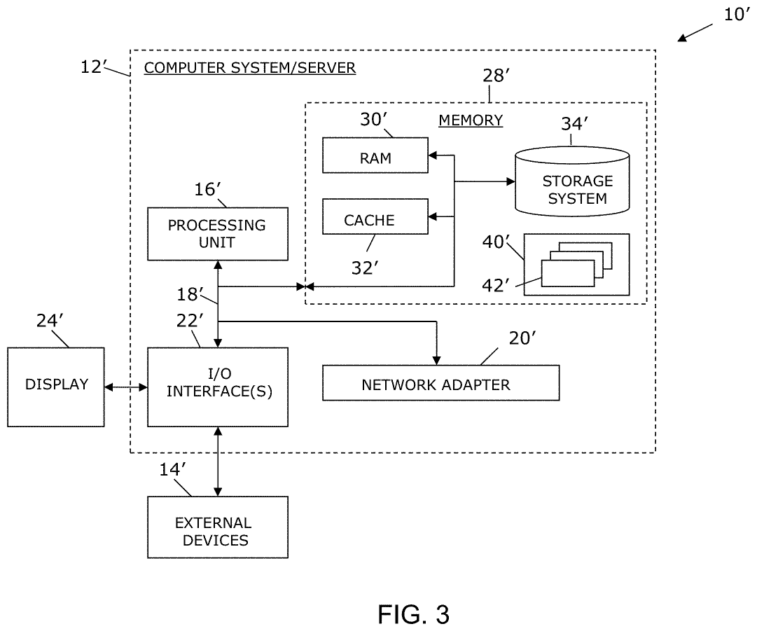

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

A problem with the traditional techniques for advertisement within the streaming services is that since the advertisements are typically provided as a separate window, the advertisements are easy for users to ignore or minimize. For example, if the advertisement is provided within a sidebar, the user can easily ignore the advertisement. As another example, if the advertisement is provided as a pop-up window, the user very quickly minimizes or closes the pop-up window. As a further example, if the advertisement is provided as a frame or scene within the video, the user typically “watches” the advertisement for the required length of time before it can be closed. However, the user is typically not paying attention to the advertisement and is instead focused on the timer that is indicating how long it will be before the user can close the advertisement and return to the desired video. Therefore, the advertisement is not as effective as it could be because many users do not see the advertisement.

There are many issues with the advertisements that are provided within streaming services, particularly, since the user is not generally required to consume the advertisement, meaning the user has techniques for closing, minimizing, or altogether ignoring the advertisement. Therefore, in order to draw more attention, the advertisement should be more related to something that the consumer may find interesting. In other words, the advertisement would be more effective if the user is interested in the content of the advertisement. However, currently, the advertisements do not take into account the preferences of the user. Additionally, the advertisements are frequently inserted at critical scenes within the video (e.g., right before results are announced on a competition show, right before a shocking secret is revealed on a sitcom, etc.) which frustrates the user and just causes a bad viewing experience and the user to be completely uninterested in the advertisement. However, if the advertisement were inserted after this critical scene, the user may no longer be invested in the video and may not watch the advertisement at all.

Accordingly, the techniques and systems as described herein provide a system and technique for inserting an advertisement that is relevant to a video within a location of a scene within the video selected based upon criticality of the scene. The system obtains a video into which an advertisement is to be inserted. The system then selects an advertisement for insertion into the video. Selecting the advertisement includes analyzing the video to identify content contained within the video or context of the video. The system then selects an advertisement that fits with or corresponds to such a context. For example, if the video is an exercise video, the system may select an advertisement for exercise equipment as opposed to a video for a car. As another example, if the video is a video showing ways to enjoy a hot summer day, the system may select an advertisement for air conditioning as opposed to an advertisement for office supplies.

After the advertisement is selected, the system may determine a location within the video to insert the advertisement. Selecting the location may include not only identifying a particular frame or scene in the video but also how to insert the advertisement within the video. For example, the system may identify whether the scene is a critical scene. In the case of a non-critical scene, the system may use one of three example techniques for insertion of the video. One example insertion technique is to insert the advertisement between frames of the video. Another example insertion technique is to replace an object of the video with an object of the advertisement. Yet another example insertion technique is to insert the advertisement at a location within a frame that is considered a non-critical or non-featured frame location (e.g., the bottom of the frame, the top of the frame, in a corner of the frame, etc.). If the scene is considered critical, the system may choose between replacing an object within a frame and inserting the advertisement at a location within the frame, thereby preventing splitting of a critical scene. Once the location is determined, the system may insert the selected advertisement at the identified location.

Such a system provides a technical improvement over current systems for advertisement insertion into videos. The described system can identify a context or category of the video and then insert an advertisement that corresponds to the context or category. In other words, the advertisement is related to the video, thereby providing an advertisement that may be more enticing to a user than what might be provided using traditional techniques that insert advertisements that are not based on the video content. Additionally, the advertisement is inserted in a location within the video that ensures consumption of the advertisement but does not result in a bad viewing experience for the user. For example, instead of splitting a critical scene with an advertisement, the system may insert the advertisement into a frame of the critical scene, thereby allowing the user to see the critical scene without interruption, but still providing exposure of the advertisement. Thus, the described system and method is a more effective technique for advertisement insertion that results in a good viewing experience to the user, which is not found with the traditional techniques.

FIG. 1 illustrates a method for inserting an advertisement, relevant to a video, at a location of a scene within the video, in which the insertion method is selected based upon criticality of the scene. At 101 the system may obtain at least one video into which an advertisement is to be inserted. The video includes any dynamic image, for example, a short video, a movie, a self-recording, or the like. The video may be obtained from a secondary source containing a plurality of videos, for example, a video database, a social media site having a plurality of videos, a video sharing site, or the like. To obtain the video, the system may access the secondary source and extract the video from the secondary source. Alternatively, a user may provide the video to the system. For example, a video generator may provide the video to the system for insertion of an advertisement. As another example, a user may identify a video that needs an advertisement inserted. In obtaining a video, the system may also obtain metadata that are associated with the video, for example, an author of the video, text embedded within the video, tags included with the video, a location where the video was stored, and the like.

At 102 the system selects an advertisement for insertion within the obtained video(s). To select the advertisement, also referred to as an ad, the system may first analyze the video to identify context of the video or content included within the video. The analysis of the video may include a video or image analysis that can be used on frames of the video to identify objects, people, or other entities included within the video. The system may also analyze the video using a text analysis technique that can analyze any text embedded within the video or metadata text that may have been included with the video. The text analysis technique may include a natural language processing technique, a syntactic text analysis technique, semantic text analysis technique, or the like, that allows the system to understand a context of the text. The system can also analyze any audio corresponding to the video using an audio analysis technique. The audio analysis technique may include converting the audio to text using a speech to text technique and then analyzing the text using a text analysis technique. From the analysis, the system attempts to gain a semantic understanding of a scene within the video by understanding objects, events, user actions, type of scene, people, audio or speech, and the like, that are contained within the scene or video.

Based upon the context of the video the system can select an ad that is related to the context of the video. For example, the system may perform an analysis similar to the video analysis on an advertisement to identify the context of the advertisement. Identifying the context of the ad may include receiving information from the advertiser that produced or provided the advertisement. For example, the advertisement may include information with the ad that identifies the context of the advertisement or that identifies what video contexts the advertisement is related to. The system can then compare the context of the advertisement to the context of the video and determine whether the contexts are the same or similar.

The selection of the advertisement may be fine-tuned to more than just context of the advertisement. For example, the system may determine an expected viewer of the video and identify one or more characteristics of the viewer (e.g., age, geographical location, gender, etc.). The advertisement may then be selected not only based upon the context of the video, but also based upon the characteristic of an expected viewer. For example, if the viewer is expected to be younger than thirteen, the system may not select an advertisement for college courses at a nearby college. As another example, if the viewer is expected to be older than fifty-five, the system may select an advertisement for a retirement community. The selection of the advertisement may also be fine-tuned based upon user preferences. For example, the user or viewer watching the video may have identified ads that are relevant to the viewer. Therefore, the system may select these types of ads.

At 103 the system may determine whether a location for insertion of the advertisement within the video can be determined. To determine the location, the system may determine not only a scene or frame into which the advertisement is to be inserted, but also how the advertisement should be inserted within the video. To determine an advertisement insertion point, the system may use one or more machine learning models that are trained to detect scene changes. For example, the machine learning model may identify when one scene is ending and another scene is beginning. As an example, the system may identify that, within a cooking video, one scene is the chef cooking in the kitchen and another scene concerns food being placed on a table. The system may then determine that this would be a good insertion location. Additionally or alternatively, the system may identify frame continuity or discontinuity to identify when the video is moving from one scene to another scene.

Once the scene for insertion of the advertisement is identified, the system may determine whether the scene is critical. A critical scene may be considered a scene where the viewing audience has become invested in the next frame of the scene. In other words, a critical scene is a scene where a user would be upset if the scene is interrupted because the user wants to see what happens next. An example of a critical scene includes a scene announcing the winner of a competition show. The user may be very unhappy if an advertisement interrupted the scene right before the announcement was made. Another example of a critical scene is when a major event in the video is about to occur (e.g., a shocking secret is revealed in a sitcom, a main character proposes in a romantic comedy movie, a point is scored in a live sporting event, a new product is announced in a product announcement video, etc.). An advertiser may prefer that an advertisement be provided during a critical scene because it is a scene that a large fraction of the viewers would be watching, thereby increasing the consumption of the advertisement.

After the ad is selected, a scene location is identified, and a determination of whether the scene is critical is made, the system may select a location within the video to insert the ad. In other words, the system may determine how the ad should be inserted into the video. FIG. 2 illustrates three example techniques for inserting the advertisement within the video. One example technique for inserting the ad includes inserting the advertisement after a frame within the scene as shown in FIG. 2A. The scene shows a person running. The advertisement for a bicycle 201B is inserted after a frame of the person running 201A and before another frame of the person running 201C. In other words, the scene is split by the advertisement.

Another example insertion technique is shown in FIG. 2B where the advertisement is inserted within a frame of the scene. The scene is a person running. The advertisement for the bicycle 202B is inserted in a frame of the person running 202A. In this example insertion technique, the system inserts the advertisement at a location within the frame that is considered a non-critical or non-featured frame location. In the example of FIG. 2B, the non-featured frame location is at the bottom right corner of the frame. However, the non-featured frame location may be any frame location where an object or other entity of the frame that is necessary for understanding the frame is not located. Thus, the non-featured frame location may be at the bottom of the frame, in a corner of the frame, at the top of the frame, within the background of the frame, or the like.

Another example insertion technique is shown in FIG. 2C where an object of the video is replaced with an object of the advertisement. The scene is of a person performing or playing a sport. In the example of FIG. 2C, the basketball 203A of the scene is replaced with a bicycle 203B that corresponds to the object of the advertisement. To replace an object with the scene, the system first determines if a similar object is already included in the video. For example, if the advertisement is for a drink, the system may determine whether a drink is already present within the video scene. As in the example of FIG. 2C, the system identifies that a basketball corresponds to an object used to play a sport, so it may be acceptable to replace this object with the bicycle which may also be used in a sport. However, not only does the system determine if a similar object is present, but the system also determines whether it would make sense to replace the object based upon the context of the video. For example, the system would not want to replace the basketball with the bicycle if the video is a basketball game. Then it would not make sense to replace the basketball with a bicycle in that context. However, if the person in the video is simply illustrating different sports or games that could be played outside, the replacement of the basketball with the bicycle makes sense. To replace the object, the system can use image segmentation techniques and graphical models to map the new object to the object currently in the frame so that the frame maintains continuity.

Determining what insertion technique to use may be based upon whether the scene was identified as critical or non-critical. In a non-critical scene, the viewer would not be upset if the scene was split by an advertisement. Thus, for a non-critical scene the system may select any of the three insertion techniques. However, for a critical scene, the viewer may be upset if the scene is split. Therefore, the system may only select either the object replacement technique or the object within a frame insertion technique. Selecting the insertion technique may be based upon the difficulty associated with the insertion technique. For example, if an object cannot be easily replaced, the system may choose the object within a frame insertion technique. As another example, if replacement of an object within the frame would render the frame inaccurate with respect to the context, the system may choose the object within a frame insertion technique.

If a location for insertion of the advertisement cannot be determined at 103, the system may choose a different video for insertion of the ad at 105. Alternatively, the system may choose a different ad for insertion into the video, may choose a different scene for insertion of the ad, or the like. If, however, the system can determine a location for insertion of the ad within the video at 103, the system may insert the ad at the determined location at 104. Insertion of the ad can be performed using a frame or image merge technique, a frame insertion technique, or an object mapping technique, depending on the insertion technique.

Once the ad has been inserted, the system may charge the advertiser for insertion of the ad within the video. The pricing may be dynamically adjusted based upon the insertion technique that was selected. For example, replacing an object within a frame with an advertiser object may cost more than simply inserting a frame into the video. As another example, inserting the advertisement at a non-critical scene may cost less than inserting the advertisement at a critical scene. Other factors may change the pricing for ad insertion. For example, the pricing may also be based upon a rating of the video, how many viewers have viewed the video, the age group that is targeted by that video, and the like.

Thus, the described advertisement insertion technique provides a significant technical improvement over current advertisement insertion techniques. Rather than inserting ads that are irrelevant to the video, the system attempts to determine the context of the video and insert an ad that is related to that context. Therefore, the user may be more interested in actually watching the advertisement. Additionally, the advertisement is inserted in a location within the video that does not interrupt critical scenes, thereby providing a better viewing experience to the user than traditional methods. Thus, the described system provides a more effective advertisement system that does not result in a bad viewing experience for a consumer.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
obtaining at least one video into which an advertisement is to be inserted;
selecting an advertisement for insertion into the at least one video, wherein the selecting comprises (i) analyzing the at least one video to identify context of the at least one video and (ii) selecting an advertisement that is related to the context of the at least one video;
determining a location within the at least one video for insertion of the advertisement, wherein the determining a location comprises (i) identifying criticality of a scene within the video where the advertisement is to be inserted and (ii) selecting the location based upon the criticality of the scene; and
inserting the advertisement within the at least one video at the determined location.

2. The method of claim 1, wherein the selecting an advertisement comprises (i) identifying a characteristic of a viewer viewing the at least one video and (ii) selecting an advertisement directed to a viewing audience having the identified characteristic.

3. The method of claim 1, wherein the selecting an advertisement comprises receiving information from an advertiser identifying a video context related to the advertisement.

4. The method of claim 1, wherein the scene is identified as a non-critical scene and wherein the location comprises a frame located within the non-critical scene.

5. The method of claim 1, wherein the scene is identified as a critical scene and wherein the selecting a location comprises replacing an object within the critical scene with an object of the advertisement.

6. The method of claim 5, wherein the replacing comprises (i) determining whether the critical scene contains an object similar to the object of the advertisement and (ii) replacing the object of the critical scene if the object of the critical scene is similar to the object of the advertisement.

7. The method of claim 5, wherein the replacing comprises (i) determining whether the replacement of the object would change the context of the critical scene and (ii) replacing the object if the replacement would not change the context of the critical scene.

8. The method of claim 1, wherein the scene is identified as a critical scene and wherein the location comprises a location, within a frame of the critical scene, corresponding to a non-featured portion of the frame.

9. The method of claim 1, comprising dynamically adjusting a price charged to an advertiser for the insertion of the advertisement based upon the determined location.

10. The method of claim 1, wherein the analyzing the at least one video comprises (i) analyzing frames of the at least one video to identify objects within the video, (ii) analyzing text embedded within the at least one video, and (iii) analyzing audio corresponding to the at least one video.

11. An apparatus, comprising:
at least one processor; and
a computer readable storage medium having computer readable program code embodied therewith and executable by the at least one processor, the computer readable program code comprising:
computer readable program code configured to obtain at least one video into which an advertisement is to be inserted;
computer readable program code configured to select an advertisement for insertion into the at least one video, wherein the selecting comprises (i) analyzing the at least one video to identify context of the at least one video and (ii) selecting an advertisement that is related to the context of the at least one video;
computer readable program code configured to determine a location within the at least one video for insertion of the advertisement, wherein the determining a location comprises (i) identifying criticality of a scene within the video where the advertisement is to be inserted and (ii) selecting the location based upon the criticality of the scene; and
computer readable program code configured to insert the advertisement within the at least one video at the determined location.

12. A computer program product, comprising:
a computer readable storage medium having computer readable program code embodied therewith, the computer readable program code executable by a processor and comprising:
computer readable program code configured to obtain at least one video into which an advertisement is to be inserted;
computer readable program code configured to select an advertisement for insertion into the at least one video, wherein the selecting comprises (i) analyzing the at least one video to identify context of the at least one video and (ii) selecting an advertisement that is related to the context of the at least one video;
computer readable program code configured to determine a location within the at least one video for insertion of the advertisement, wherein the determining a location comprises (i) identifying criticality of a scene within the video where the advertisement is to be inserted and (ii) selecting the location based upon the criticality of the scene; and
computer readable program code configured to insert the advertisement within the at least one video at the determined location.

13. The computer program product of claim 12, wherein the selecting an advertisement comprises (i) identifying a characteristic of a viewer viewing the at least one video and (ii) selecting an advertisement directed to a viewing audience having the identified characteristic.

14. The computer program product of claim 12, wherein the selecting an advertisement comprises receiving information from an advertiser identifying a video context related to the advertisement.

15. The computer program product of claim 12, wherein the scene is identified as a non-critical scene and wherein the location comprises a frame located within the non-critical scene.

16. The computer program product of claim 12, wherein the scene is identified as a critical scene and wherein the selecting a location comprises replacing an object within the critical scene with an object of the advertisement.

17. The computer program product of claim 16, wherein the replacing comprises (i) determining whether the critical scene contains an object similar to the object of the advertisement and (ii) replacing the object of the critical scene if the object of the critical scene is similar to the object of the advertisement.

18. The computer program product of claim 16, wherein the replacing comprises (i) determining whether the replacement of the object would change the context of the critical scene and (ii) replacing the object if the replacement would not change the context of the critical scene.

19. The computer program product of claim 12, wherein the scene is identified as a critical scene and wherein the location comprises a location, within a frame of the critical scene, corresponding to a non-featured portion of the frame.

20. A method, comprising:
obtaining a video for insertion of an ad, wherein the obtaining comprises identifying a category of the video based upon content in the video;
obtaining an ad for insertion into the video, wherein the obtaining an ad comprises matching a category of the ad to the category of the video;
selecting a position within a scene of the video for insertion of the ad, wherein the selecting comprises identifying a critical scene within the video;
inserting the ad into the video, wherein the inserting comprises (i) replacing an object within a frame of the critical scene if an object of the ad is similar to the object within the frame and (ii) inserting, if an object cannot be replaced, the ad at a position within a frame of the critical scene, the position being identified as a non-featured frame element.
